(19) United States
(12) Patent Application Publication
(10) Pub. No.: US 2016/0233578 A1
(43) Pub. Date: Aug. 11, 2016

(54) FLIGHT VEHICLE RADOME AND METHOD FOR PRODUCING FLIGHT VEHICLE RADOME

(71) Applicant: MITSUBISHI ELECTRIC CORPORATION, Chiyoda-ku (JP)

(72) Inventors: Masami KUME, Chiyoda-ku (JP); Hiroki KOBAYASHI, Chiyoda-ku (JP)

(73) Assignee: MITSUBISHI ELECTRIC CORPORATION, Chiyoda-ku (JP)

(21) Appl. No.: 15/015,503

(22) Filed: Feb. 4, 2016

(30) Foreign Application Priority Data
Feb. 9, 2015 (JP) 2015-023130
Jan. 5, 2016 (JP) 2016-000388

(51) Int. Cl. H01Q 1/42; B29C 65/48; B29C 70/34; H01Q 1/28; B29C 70/16

(52) U.S. Cl. CPC H01Q 1/422; H01Q 1/28; B29C 70/16; B29C 70/34; B29C 65/48; B29K 2309/14; B29K 2105/0845

(57) ABSTRACT

A flight vehicle radome according to the present invention has a shape that covers radio equipment installed in a flight vehicle. The flight vehicle radome is formed of a sandwich panel structure in which a core member (30) resulting from foaming and compositing of a heat-resistant resin (32) and insulating reinforcing fibers (31) is sandwiched between skin members (20) made of a fiber reinforced material being a composite of quartz cloth (20) and a heat-resistant resin (22).

### BACKGROUND OF THE INVENTION

1. Field of the Invention

The present invention relates to a flight vehicle radome that protects radio equipment installed in a flight vehicle such as aircraft, from the external environment, and to a method for producing a flight vehicle radome.

2. Description of the Related Art

Radio equipment such as various kinds of antennas and radar are installed in flight vehicles such as aircraft. Such radio equipment is protected from the external environment by being covered by a radome. Radomes are required to be not only durable, in terms of being capable of protecting the radio equipment, but also to exhibit radio characteristics in terms of enabling sufficient transmission of the radio waves that are exchanged by the radio equipment.

The specific configuration of radomes for flight vehicles is not particularly limited. However, further reductions in the weight of aircraft have come to be demanded in recent years, for instance from the viewpoint of increasing fuel efficiency. Accordingly, lighter radomes for flight vehicles that utilize fiber-reinforced plastics (FRPs) have come to be adopted.

Ordinarily, such radomes are configured by using singly an FRP material having good radio wave transmission characteristics, or by using a sandwich structure resulting from combining an FRP material with a core member (honeycomb core, foam core or the like).

In the conventional art there are radomes for flight vehicles made up of a curved sandwich structure in which a core is made of a polyetherimide foam material, and a face plates that sandwich both faces of the core are a single layer or a plurality of layers made of a cyanate resin FRP (for instance, Japanese Patent No. 3572517).

Other instances of conventional art include sandwich structures that are provided with a body portion having a shape that covers radio equipment installed a flight vehicle, and an attachment section by way of which the body portion is attached to the flight vehicle, wherein in the body portion and the attachment section the surface of the core member is covered with a series of face plates, the core member of the attachment section is a composite structure formed of a thermosetting resin composition that is reinforced with fibers, and the reinforced resin layer that makes up the composite structure includes a resin layer of a type different from that of the face plates (for instance, Japanese Patent No. 5320278).

There are also conventional technologies pertaining to sandwich structures in which a core formed of a syntactic foam resulting from mixing inorganic microballoons into a polyimide resin is sandwiched between, and bonded to, two skin members made of a fiber-reinforced polyimide resin (for instance, Japanese Patent Application Publication No. H07-1673).

### SUMMARY OF THE INVENTION

Conventional technologies have however the following problems. Although the temperature on the outer surface of the radome in aircraft flying at supersonic speed varies depending on flight speed, flight altitude, flight time and so forth, that temperature is expected to reach 300° C. or higher in some instances on account of aerodynamic heating during flight. Heat generation due to transmission loss of radio waves may pose a further problem in cases where wave transmission takes place during flight. Accordingly, the temperature of the radome may conceivably rise further in some instances on account of such transmission loss.

For example, ceramic materials are highly heat-resistant materials and boast excellent radio wave transmissivity. However, ceramic materials are heavy, impact-vulnerable, brittle and fragile, and therefore are not used in manned aircraft, for safety reasons.

By contrast, polyimide resins are an example of FRP matrix resins that can be used in such high-temperature conditions in cases where a high-toughness composite material difficult to break is employed. Polyimide resins have been problematic however in that sufficient strength and stiffness in a core of polyimide resin may be difficult to obtain in cases where the polyimide resin is foamed to yield a foam material. Lowering herein the foaming ratio gives rise to problems such as increased weight and poorer radio wave transmissivity.

Moreover, the resulting foam body is of open-celled structure (open voids), and the resin permeates readily into the skin members upon bonding with the latter. This resulted in resin shortfall and poorer adhesiveness, and made integration harder to achieve. It was thus difficult to realize a three-dimensional integrated radome shape in the form of a sandwich structure.

The flight vehicle radome described in Japanese Patent No. 3572517 is made up of a curved-surface sandwich structure having a single layer or plurality of layers of small curvature. A core is made up of a polyetherimide foam material and face plates that sandwich both faces of the core are made up of a cyanate resin FRP. Thus, a cyanate resin is used in the face plates of the surface of the sandwich structure of the flight vehicle radome described in Japanese Patent No. 3572517. Heat resistance was accordingly insufficient at temperatures of 300° C. or higher, and it was difficult to use the radome over long periods of time.

When increasing the foaming ratio and lowering the specific gravity of a core member resulting from foaming of a polyimide resin that can be used in high-temperature conditions, however, the obtained member was no longer suitable as a core member on account of lowered strength and stiffness. Meanwhile, foam core members with a lowered foaming ratio of the polyimide resin exhibit high strength and stiffness, but are heavier, have lower radio wave transmittance, and incur a greater dielectric loss. It has been accordingly difficult to combine higher strength and stiffness while avoiding impairment of radio characteristics.

The flight vehicle radome of Japanese Patent No. 3572517 exhibits low thermal conductivity, while heat generated due to radio absorption loss during radar output cannot propagate efficiently to the exterior. This was problematic on account of the rise in temperature associated therewith.

Japanese Patent No. 5320278 discloses examples of various materials in surface members and a core member of a sandwich build-up. However, all combinations of such materials were problematic in that the materials failed to satisfy conditions of light weight, strength/stiffness, radio characteristics and heat resistance, when used as radome materials of aircraft flying at supersonic speed.

Japanese Patent Application Publication No. H07-1673 discloses a sandwich material for radomes in which a syntactic foam material is used in a core member. However, the core that uses a syntactic foam material has the drawbacks of being heavier than a honeycomb core, as in the case of a foam core member, and of being deficient in radio wave transmissivity and dielectric loss. Therefore, also the structure described in Japanese Patent Application Publication No. H07-1673 is unsuitable as a radome material for use in supersonic flight vehicles.

It is thus an object of the present invention, which was arrived at with a view to solving the above problems, to provide a flight vehicle radome having a sandwich structure of three-dimensional shape that is lightweight and excellent in radio wave transmissivity, and to provide a method for producing a flight vehicle radome.

The flight vehicle radome according to the present invention is a flight vehicle radome having a shape that covers radio equipment installed in a flight vehicle. The radome is formed of a sandwich panel structure in which a core member resulting from foaming and compositing a heat-resistant resin and electrically-insulating reinforcing fibers is sandwiched between skin members made of a fiber reinforced material being a composite of quartz cloth and a heat-resistant resin.

The method for producing a flight vehicle radome according to the present invention is a method for producing a flight vehicle radome that is formed of a sandwich panel structure in which a core member is sandwiched between skin members, the method comprising: a first step of producing the core member by impregnating a wool made of electrically-insulating quartz continuous fibers, as reinforcing fibers, with a heat-resistant resin diluted in a solvent, to impart tackiness; a second step of producing the skin members by stacking prepreg sheets resulting from impregnation of quartz cloth with the heat-resistant resin, and heat-curing the prepreg sheets using a molding die; and a third step of producing an integrated sandwich structure by sandwiching the core member produced in the first step between the skin members produced in the second step.

The present invention allows configuring a flight vehicle radome in the form of a sandwich structure that results from combining FRP molded bodies, to yield an integrated structure that does not break readily and that boasts thus superior mechanical characteristics, in terms of light weight strength and stiffness, as compared with ceramic radomes, and allows also realizing electric characteristics in terms of high radio wave transmissivity. As a result there can be achieved a flight vehicle radome, and a method for producing a flight vehicle radome, wherein the radome has excellent transmissivity to radio waves and structural strength, and also such heat resistance as allows the radome to withstand aerodynamic heating at supersonic speed as well as increases in temperature when the radome is used for radar.

### BRIEF DESCRIPTION OF THE DRAWINGS

FIG. 1 is a cross-sectional diagram illustrating a sandwich structure of a radome in Embodiment 1 of the present invention;

FIG. 2 is an enlarged-view diagram of a partial cross-section of a sandwich structure of a radome in Embodiment 1 of the present invention;

FIG. 3 is a flowchart pertaining to a production process of a radome in Embodiment 2 of the present invention;

FIG. 4 is an explanatory diagram illustrating a production procedure of skin members for a radome in Embodiment 2 of the present invention;

FIG. 5 is an explanatory diagram illustrating a production procedure of a core member in Embodiment 2 of the present invention; and

FIG. 6 is an explanatory diagram illustrating a production procedure of sandwiching skin members and a core member in Embodiment 2 of the present invention.

### DETAILED DESCRIPTION OF THE PREFERRED EMBODIMENTS

Preferred embodiments of the flight vehicle radome and the method for producing a flight vehicle radome according to the present invention will be explained next with reference to accompanying drawings.

### Embodiment 1

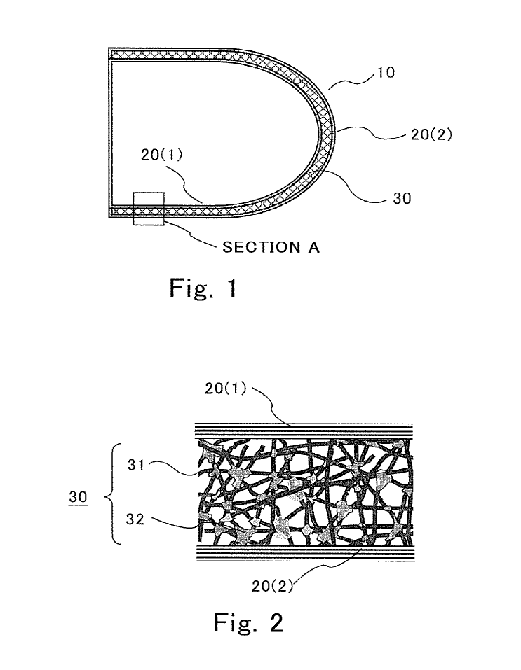

FIG. 1 is a cross-sectional diagram illustrating a sandwich structure of a radome in Embodiment 1 of the present invention. A radome 10 of the present Embodiment 1 is made up of skin members 20 (1), 20 (2) and a core member 30.

FIG. 2 is an enlarged-view diagram of a partial cross-section of the sandwich structure of the radome of Embodiment 1 of the present invention. More specifically, the partial cross-sectional diagram illustrated in FIG. 2 corresponds to an enlarged diagram of “section A” in FIG. 1.

The core member 30 has a structure wherein portions at which reinforcing fibers 31 intersect each other are bonded by a polyimide resin 32. The core member 30 in the present Embodiment 1 is thus is a low-density molded body provided with the reinforcing fibers 31 and the polyimide resin 32. In terms of volume ratio, preferably, the volume content ratio of the reinforcing fibers 31 ranges from 3% to 10% and the volume content ratio of the resin is 20% or lower, the core member 30 being thus a low-density molded body having an apparent bulk density of 0.3 or lower. The bulk density of cores of polyetherimide foam materials lie ordinarily in the range of about 0.6 to 0.8, and are not suitable for practical use when the bulk density drops to 0.3, on account of insufficient strength.

When the volume content ratio of the reinforcing fibers 31 is higher than 10%, a larger amount of polyimide resin 32 is necessary for fixing the fibers and for molding. As a result, the bulk density of the low-density molded body exceeds 0.3, and the core member 30 becomes heavy.

The radome structure must be produced to an optimal thickness according to the frequency of the radio waves that are used. The specific gravity of the core member 30 is preferably low in this case, from the viewpoint of radio wave transmissivity.

Conversely, when the volume content ratio of the reinforcing fibers 31 is lower than 3%, the strength and stiffness of the core member 30 when composited with the polyimide resin 32 become insufficient, and the core member 30 exhibits strength and stiffness comparable to those of foam core members. This makes the core member undesirable as a core member 30 for a sandwich structure.

Specifically, when the volume content ratio of the reinforcing fibers 31 in the core member 30 is higher than 10%, the apparent density increases beyond 0.3, and the core member 30 in the sandwich panel becomes heavy, which nullifies the benefits of weight reduction.

Strength and stiffness as a sandwich panel are achieved if the density of the core member 30 is 0.3. When a core of yet higher density is used, the core member itself exhibits strength and stiffness as a fiber-reinforced composite material. Accordingly, the reinforcing effect elicited by the skin members 20 is no longer obtained, and weight reduction cannot be achieved, all of which is undesirable.

On the other hand, the strength and stiffness of the core member 30 decrease when the volume content ratio of the reinforcing fibers 31 is lower than 3%. As a result, strength and stiffness fail to be obtained in the sandwich panel, which is undesirable.

As the form of the reinforcing fibers 31 there are preferably used aggregates of short fibers having a length of 3 mm or more, or continuous fibers. Both short fibers and continuous fibers are used worked to a wool-like form. A low-density molded body having a bulk density lower than 0.3 can be realized, and strength and stiffness can be secured in the core member 30 used for a sandwich panel, when using fibers having a length of 3 mm or more.

When using short fibers having a length smaller than 3 mm, conversely, molding of an FRP molded body to a low specific gravity becomes difficult, and strength and stiffness drop further. Thus, using the reinforcing fibers 31 having a length smaller than 3 mm is undesirable since in that case the specific gravity of the core member 30 after molding is greater than 0.3, and strength and stiffness drop further. Accordingly, the length of the short fibers is preferably 3 mm or greater.

Continuous fibers are fibers that not result from cutting, as a post-process, of fibers obtained through spinning; short fibers, by contrast, do undergo such post-process cutting. Therefore, the length distribution of short fibers varies depending on the processing method of the fibers. The fibers resulting from cutting, referred to as chopped fibers, have generally a length of about several millimeters (ordinary sizes include herein sizes of 3 mm, 6 mm to 25 mm, while so-called milled fibers, which result not from cutting but from milling, have lengths of up to 1 mm).

The skin members 20 are FRP molded bodies obtained by compositing quartz cloth and a polyimide resin. Preferably, the volume ratio of the quartz cloth ranges from 30% to 60% and the volume ratio of the polyimide resin ranges from 70% to 40%.

A volume ratio of the polyimide resin higher than 70% is undesirable, since in that case sufficient strength and stiffness fail to be achieved in the FRP molded body. A volume ratio of the polyimide resin lower than 40% is likewise undesirable since adhesion to the quartz cloth becomes then poorer, and the strength of FRP molded body is impaired as a result.

The polyimide resin 32 that is used as the core member 30 in the present invention may be of condensation type or addition type, provided that the resin is thermosetting. The structure of the polyimide resin 32 is not particularly limited, so long as the resin allows fixing and molding short fibers randomly oriented in a cotton-like fashion. Accordingly, generally used polyimide resins may be utilized herein as the polyimide resin 32; two or more types of polyimide resins may likewise be used, as needed.

Specific examples of the polyimide resin 32 that is used as the core member 30 include, for instance, BANI-M and BANI-X by Maruzen Petrochemical Co., Ltd., SKYBOND and Pyre-ML by I.S.T. Corp.; PETI and U-varnish by Ube Industries, Ltd., and Uimide by Unitika Ltd.

The polyimide resin 22 that is used in the skin members 20 may be of condensation type or addition type, provided that the resin is thermosetting. Particularly preferably, however, the polyimide resin 22 can be cure-bonded with the core member 30. Specific examples of the polyimide resin 22 that is used as the skin members 20 include, for instance, BANI-M and BANI-X by Maruzen Petrochemical Co., Ltd., SKYBOND and Pyre-ML by I.S.T. Corp.; PETI and U-varnish by Ube Industries, Ltd., and Uimide by Unitika Ltd.

Even if the polyimide resin 22 used in the skin members 20 and the polyimide resin 32 used in the core member 30 are not identical, it does not cause any problem.

Bonding of the skin members 20 and the core member 30 is accomplished conveniently by bringing the core member 30 in contact with the skin members 20, and in that state, curing the skin members 20, to bond thereby the whole. The skin members 20 and the core member 30 may alternatively be molded separately, and be then bonded using a heat-resistant adhesive. Specific examples of the heat-resistant adhesive include, for instance, BANI-M and BANI-X by Maruzen Petrochemical Co., Ltd., SKYBOND and Pyre-ML by I.S.T. Corp.; PETI and U-varnish by Ube Industries, Ltd., and Uimide by Unitika Ltd.

Fibers having a high specific strength, excellent heat resistance and insulating properties, as well as a low dielectric constant, are preferably used as the reinforcing fibers 31. Examples thereof, among glass fibers, include E glass, S glass, NE glass, and the like, and most preferably high-purity quartz fibers.

Examples of quartz fibers include, for instance, Q glass by Shin-Etsu Quartz Products Co., Ltd. and AstroQuartz by JSL. Examples of aramid fibers include, for instance, Kevlar, Technora, Twaron and the like.

Herein glass fibers are preferred as an inorganic material while aramid fibers are preferred as an organic material. Glass fibers, in particular high-purity quartz glass fibers, are preferred since these fibers are superior in terms of high radio wave transmissivity and low dielectric loss.

A cloth 21 that is used in the skin members 20 is preferably of satin weave having a readily shifting texture, rather than of plain weave, in order for the cloth to conform readily to curved surface shapes. Specific examples of such cloth 21 include, for instance, SQF09AS-02 by Shin-Etsu Quartz Products Co., Ltd.

In Embodiment 1, thus, a radome is formed as a sandwich panel structure that is formed of skin members made of a fiber reinforced material being a composite of quartz cloth and a polyimide resin, and out of a core member made of reinforcing fibers and a polyimide resin. As a result, a radome can be realized that has a sandwich structure of three-dimensional shape, the radome being lightweight and excellent in radio wave transmissivity, and being suitable for protecting radio equipment installed flight vehicles such as aircraft, against the external environment.

### Embodiment 2

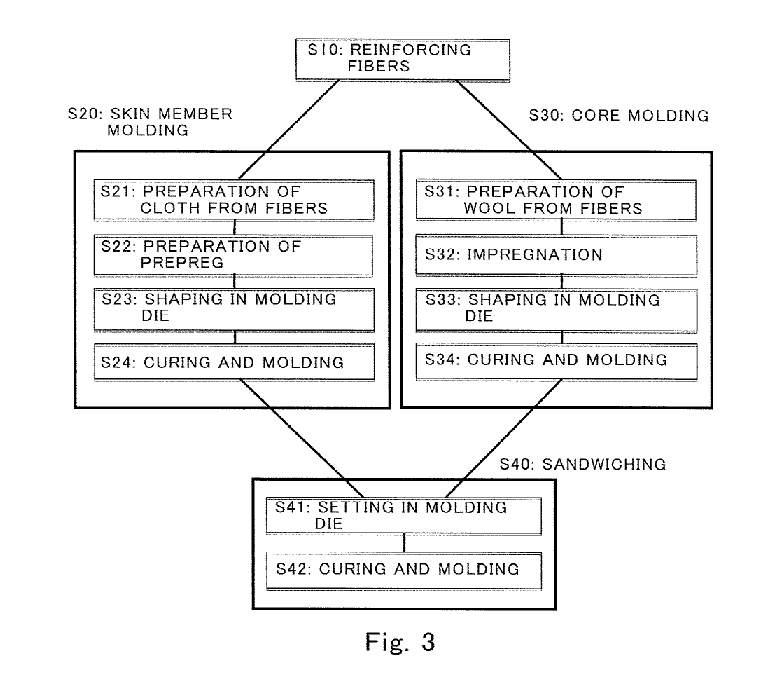

In Embodiment 2 a production process of the radome of the present invention explained in Embodiment 1 above will be described next with reference to accompanying drawings. FIG. 3 is a flowchart relating to the production process of the radome in Embodiment 2 of the present invention.

The flowchart illustrated in FIG. 3 includes roughly the following four steps below.

S10: step of preparing reinforcing fibers that are used in the skin members 20 and the core member 30.

S20: flow of molding of the skin members 20, made up of four steps S21 to S24.

S30: flow of molding of the core member 30, made up of four steps S31 to S34.

S40: flow of sandwiching of the skin members 20 and the core member 30, made up of two steps S41 and S42.

In step S10, firstly, there are prepared reinforcing fibers (corresponding to the reinforcing fibers 31 and the cloth 21) that are used in the molding flow S20 of the skin members 20 and in the molding flow S30 of the core member 30. Herein Q glass by Shin-Etsu Quartz Products Co., Ltd. was used as the reinforcing fibers. Further, SQF09AS-02 woven in the form of cloth was used for the skin members 20, and quartz wool dispersed in the form of cotton was used for the core member 30.

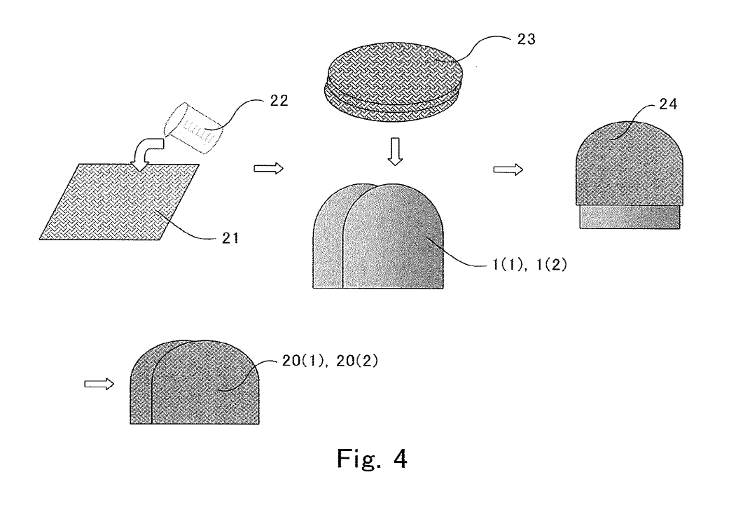

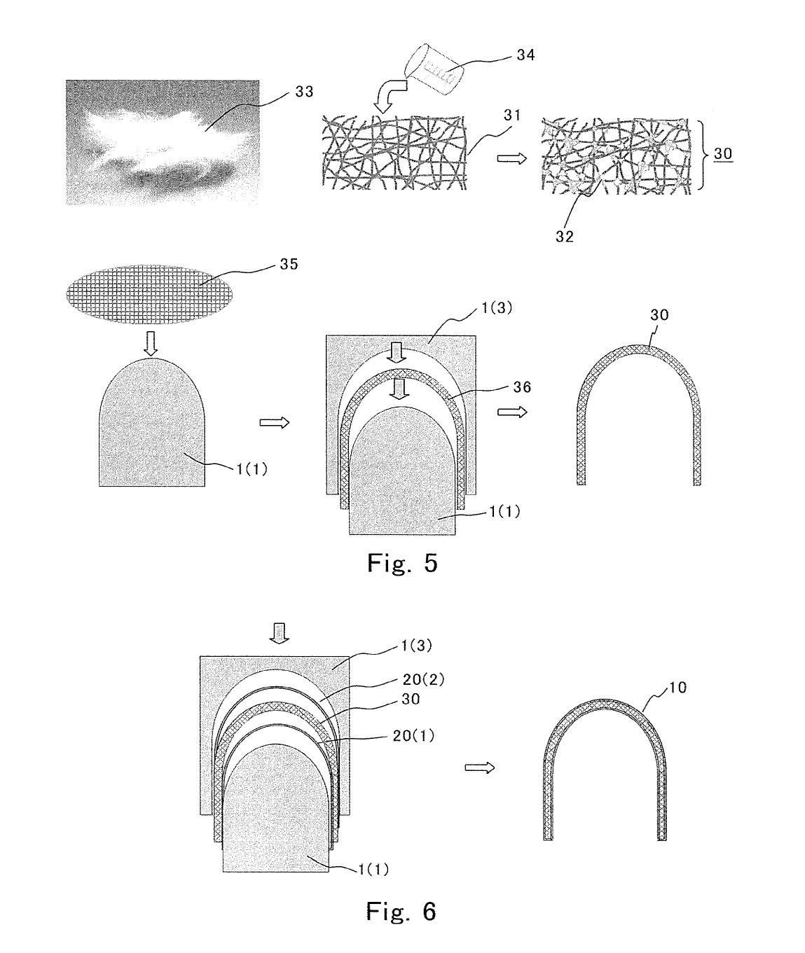

Steps S20, S30 and S40 will be explained next in detail with reference to FIG. 4, FIG. 5 and FIG. 6, respectively. FIG. 4 is an explanatory diagram illustrating a production procedure of the skin members 20 for a radome in Embodiment 2 of the present invention. FIG. 5 is an explanatory diagram illustrating a production procedure of the core member 30 in Embodiment 2 of the present invention. FIG. 6 is an explanatory diagram illustrating a production procedure of sandwiching the skin members 20 and the core member 30, in Embodiment 2 of the present invention.

The cloth 21 (SQF09AS-02 by Shin-Etsu Quartz Products Co., Ltd.) used in the skin members 20 (1), 20 (2) is prepared (corresponding to step S21), and the wool 33 used in the core member 30 is likewise prepared (corresponding to step S31), using the reinforcing fibers that have been prepared in step S10.

Molding of the skin members 20 will be explained next with reference to FIG. 3 and FIG. 4.

To make the fibers into cloth in step S21, a satin weave of readily shifting texture was selected as the cloth 21, taking into consideration shaping around a three-dimensional curved surface. The type of weave of the cloth 21 may be twill, plain weave or the like, other than satin weave, depending on the number of weaves of the fibers and according to the shaping of the fibers to the curved surface that is to be formed.

To prepare a prepreg in step S22, the woven cloth 21 is immersed in the polyimide resin 22 having been dissolved in a solvent, and thereafter the excess solvent is dried off, to yield a prepreg in the form of prepreg sheets 23. Adding micro-balloons to the solvent allows herein adjusting the viscosity of the diluted resin, facilitating control of the resin adhesion amount, lowering the specific gravity of the core member, and securing strength and stiffness.

Preferably, the adhesion amount of the polyimide resin 22 with respect to the cloth 21 is adjusted herein so as to range from 30% to 40%, in a ratio by weight. An adhesion amount of the polyimide resin 22 lower than 30% is undesirable since in this case breakage and loss of strength may occur on account of poor fixing and adhesion of the fibers, due in turn to resin shortfall during heat-curing molding. Setting the adhesion amount of the polyimide resin 22 to be higher than 40% is likewise undesirable since in this case the filling ratio of the fibers during molding decreases, and the strength and stiffness of the molded body are impaired.

In a mold shaping step S23, the prepreg sheets 23 are next stacked to a predetermined thickness on a molding die 1 (1) having the internal shape of a radome and a molding die 1 (2) having the external shape of the radome, to yield a prepreg laminate 24.

To stack the prepreg sheets 23, a deep drawing method may be adopted wherein the prepreg sheets 23 are shaped to a 3D shape, with shifting of the texture of the prepreg sheets 23 in such a manner that the prepreg sheets 23 fit the mold. Alternatively, a method may be adopted which involves stacking butted prepreg sheets 23 having been cut to a pattern of a developed view that results from developing a 3D curved surface.

Preferably, the prepreg sheets 23 are sequentially stacked in such a manner that each successive sheet overlaps the previous one, with the positions of the sheets offset from each other so that fiber orientation as well as the discontinuous butting positions of the prepreg sheets 23 are all distributed uniformly. Preferably, the thickness of the skin members 20 for a sandwich panel ranges from about 0.2 mm to about 2 mm.

The thickness necessary as a sandwich material is determined by the band of radio waves that are used. The necessary thickness of the skin members 20, in order to secure strength and stiffness when in the form of a sandwich material, is determined thereafter through strength calculation. In ranges ordinarily utilized, the outer skin thickness ranges preferably from about 0.2 mm to 2 mm, as described above, from the viewpoint of radio characteristics and in terms of striking a balance between strength and weight.

In a curing and molding step S24, next, the stacked skin members 20 are bagged and are molded through heat-curing in an autoclave. In the heat-curing step, there may be set a female die 1 (3) (see FIG. 5) that covers the outer side, whereupon molding is carried out using a press or an oven.

The configuration of the molding die 1 and the method of heating and pressing may be selected in accordance with the complexity of the shape to be molded, and thus molding is not necessarily limited to autoclave molding.

As a result of the series of processes in step S21 to step S24 there can be molded the skin member 20 (2) for the skin (exterior) of the radome and the skin member 20 (1) for the interior.

Molding of the core member 30 will be explained next with reference to FIG. 3 and FIG. 5.

In step S31 of making the fibers into a wool, the core member 30 is prepared by cutting firstly a bundle of reinforcing fibers 31 to a length of 3 mm or greater, cleaning off a sizing agent adhered to the fibers, to remove the sizing agent, and subjecting the fibers to a fiber-opening process, to yield cotton-like fibers. The cleaning solvent may be selected herein in accordance with the type of sizing agent that is adhered to the fibers.

The reinforcing fibers 31 were cleaned through stirring in an aqueous solution, having mixed thereinto a solvent that dissolves the sizing agent. Once the fibers were opened through unraveling of fiber bundles with sufficient stirring, the aqueous solution was filtered off, and the fibers were thereafter dried to prepare a wool 33 for the core member 30.

In an impregnation step S32, next, the wool 33 is impregnated with a resin 34 for a matrix having been diluted with a solvent, to yield a preform 35. In order to prevent excessive adhesion of the polyimide resin 32 to the wool 33, the dilution rate of the polyimide resin 32 was tested beforehand in a preliminary test, and step S32 was carried out after adjustment of the concentration of the polyimide resin 32.

As a result, the polyimide resin 32 became adhered in the vicinity of intersections of the fibers within the wool 33, as illustrated in FIG. 5; herein the adhesion amount of the polyimide resin 32 was adjusted in such a manner that the bulk density after drying and curing of the polyimide resin 32 was 0.3 or lower and the content of the fibers ranged from 3% to 10% in volume ratio.

In a mold shaping step S33, next, the preform 35 was set between a male die 1 (1) and a female die 1 (3) of a radome molding die 1, and the preform 35 was deformed through pressing. The deformed preform 36 was then cured and molded through heating, to yield the core member 30. The polyimide resin 34 need not be heated herein until complete curing. In the present Embodiment 2, heating was carried out up to a B-stage state (tack-free, apparently cured semi-cured state).

If the polyimide resin 34 is cured completely, the core member 30 and the skin members 20 cannot be bonded or integrated together in a subsequent sandwiching step with the skin members 20, and accordingly an adhesive must be used. Therefore, molding of the skin members 20 and the core member 30 is preferably carried out as a result of a thermal treatment up to a B-stage state. The skin members 20 and the core member 30 can be integrally bonded, and workability improved, when using thus the skin members 20 and the core member 30 having been processed up to the B-stage state.

Sandwiching of the skin members 20 and the core member 30 will be explained next with reference to FIG. 3 and FIG. 6.

In step S41 of setting in the molding die, the skin members 20 (1), 20 (2) and core member 30 having been molded in a thermal treatment up to a B-stage state are set in radome molding dies 1 (1), 1 (3), as illustrated in FIG. 6.

In curing and molding step S42, an integrated sandwich structure is obtained through sufficient heat-curing. Polyimide resins characteristically generate a substantial amount of decomposition gas when cured, which gives rise to foaming in the confined space between dies. By virtue of this foaming behavior, the resin is cured with the fibers of the core member becoming randomly dispersed and cross-linked. The fibers and the polyimide resin of the core member are composited as a result, and there is obtained a low-density core of high strength and stiffness, i.e. imparted with tackiness, and a lightweight high-strength high-stiffness sandwich structure is likewise obtained.

In a final integration step according to step S40, the skin members 20 and the core member 30 are not necessarily limited to undergoing a thermal treatment up to the B-stage state. For instance, the completely cured skin members 20 and core member 30 may be combined, or alternatively a B-stage article or a completely cured article may be combined. In this case an adhesive may be used between the skin members 20 and the core member 30 in order to secure sufficient adhesive strength.

When the viscosity of the adhesive is low, the latter flows readily and adhesion defects are prone to occur. Accordingly, it is preferable to use an adhesive having been adjusted to be of high viscosity type. Microballoons or the like may be used in order to adjust viscosity.

As explained in the technical problem section of the present invention, the temperature of the outer surface of the radome can be expected to reach in some instances 300° C. or higher, on account of aerodynamic heating during flight, in aircraft flying at a supersonic speed. Polyimide resins boasting excellent heat resistance are herein an example of FRP matrix resins that can be used as high-toughness composite materials that do not break readily in such environments.

When forming a core member through foaming of a polyimide resin, however, it was difficult to obtain sufficient strength and stiffness as a core, while lowering herein the foaming ratio gave rise to problems such as increased weight and poorer radio wave transmissivity.

Moreover, the resulting foam body was of open-celled structure (open void), and the resin permeated readily upon bonding with the skin members. This resulted in resin shortfall, poorer adhesiveness, and made integration harder to achieve. It was thus difficult to realize a 3D integrated radome shape in the form of a sandwich structure.

In contrast to such problems, the production method according to the present Embodiment 2 allows obtaining a radome in the form of a sandwich panel structure by utilizing a polyimide resin having excellent heat resistance in the core member and in the skin members, and utilizing, as the core member, reinforcing fibers having excellent transmissivity to radio waves and structural strength, made into a wool. As a result it becomes possible to realize a radome having excellent transmissivity to radio waves and structural strength, and also such heat resistance as allows the radome to withstand aerodynamic heating at supersonic speed and also increases in temperature when the radome is used for radar.

In Embodiments 1 and 2 described above a polyimide resin is used as the heat-resistant resin, but the present invention is not limited thereto. Some other heat-resistant resin can be used provided that the resin allows achieving heat resistance at 300° C. or above (i.e. the resin has a glass transition temperature Tg of 300° C. or higher), in a flight vehicle radome having a sandwich panel structure.

What is claimed is:

1. A flight vehicle radome having a shape that covers radio equipment installed in a flight vehicle,
the radome being formed of a sandwich panel structure in which a core member resulting from foaming and compositing a heat-resistant resin and insulating reinforcing fibers is sandwiched between skin members made of a fiber reinforced material being a composite of quartz cloth and a heat-resistant resin.

2. The flight vehicle radome of claim 1,
wherein the heat-resistant resin used in the skin members and in the core member is a polyimide resin.

3. The flight vehicle radome of claim 1,
wherein the reinforcing fibers used in the skin members and in the core member are quartz fibers.

4. The flight vehicle radome of claim 1,
wherein the heat-resistant resin used in the skin members and in the core member has a Tg of 300° C. or higher.

5. The flight vehicle radome of claim 1,
wherein the core member has a fiber content ranging from 3% to 10% and a bulk density of 0.3 or lower.

6. The flight vehicle radome of claim 1,
wherein the reinforcing fibers used in the core member are short fibers of 3 mm or longer, or continuous fibers.

7. A method for producing a flight vehicle radome that is formed of a sandwich panel structure in which a core member is sandwiched between skin members, the method comprising:
a first step of producing the core member by impregnating a wool made of insulating quartz continuous fibers, as reinforcing fibers, with a heat-resistant resin diluted in a solvent, to impart tackiness;
a second step of producing the skin members by stacking prepreg sheets resulting from impregnation of quartz cloth with the heat-resistant resin, and heat-curing the prepreg sheets using a molding die; and
a third step of producing an integrated sandwich structure by sandwiching the core member produced in the first step between the skin members produced in the second step.

8. The method for producing a flight vehicle radome of claim 7,
wherein a polyimide resin is used as the heat-resistant resin in the first step and the second step.

9. The method for producing a flight vehicle radome of claim 7,
wherein impregnation in the first step involves mixing microballoons into the solvent.
